(19) United States
(12) Patent Application Publication
(10) Pub. No.: US 2006/0059909 A1
(43) Pub. Date: Mar. 23, 2006

(54) Supercharged internal combustion engine

(76) Inventors: Uwe R. Spaeder, Aachen (DE); Norbert A. Schorn, Aachen (DE); Helmut M. Kindl, Aachen (DE); Rob Stalman, Selfkant (DE)

Correspondence Address: FORD GLOBAL TECHNOLOGIES, LLC., SUITE 600 - PARKLANE TOWERS EAST, ONE PARKLANE BLVD., DEARBORN, MI, 48126, US

(21) Appl. No.: 11/232,531

(22) Filed: Sep. 22, 2005

(30) Foreign Application Priority Data
Sep. 22, 2004 (EP) 04104583.2

(51) Int. Cl. F02B 29/04; F02D 23/00

(52) U.S. Cl. 60/599; 60/600

(57) ABSTRACT

The invention relates to a method of operating a supercharged internal combustion engine with which high exhaust-gas recirculation rates and high charge pressures within all the load ranges, in particular within the part-load range, can be realized at the same time. This is achieved by an internal combustion engine internal combustion engine having at least two cylinders which are configured in such a way that they form two groups with in each case at least one cylinder, and both cylinder groups are each equipped with a separate exhaust-gas line, and both exhaust-gas lines are connected to one another, and having two exhaust-gas turbochargers connected in parallel, a first turbine of a first exhaust-gas turbocharger being arranged in the exhaust-gas line of the first cylinder group, and a second turbine of a second exhaust-gas turbocharger being arranged in the exhaust-gas line of the second cylinder group, and the compressors assigned to these turbines being arranged in separate intake lines which converge downstream of the compressors to form a combined intake line and serve to supply the internal combustion engine with fresh air or fresh mixture. Further, there is provided a line for the exhaust-gas recirculation, this line branching off upstream of one of the two turbines from the exhaust-gas line assigned to this turbine and opening into the combined intake line, and wherein there are provided means with which the magnitude of the exhaust-gas mass flow passed through one of the two turbines can be controlled, so that this turbine functions as selectable turbine.

### FIELD OF INVENTION

The invention relates to a supercharger for an internal combustion engine, such that high exhaust-gas recirculation rates and high charge pressures, in particular within the part-load range, can be realized at the same time.

### BACKGROUND AND SUMMARY OF THE INVENTION

The invention relates to a supercharged internal combustion engine having at least two cylinders which are configured in such a way that they form two groups with in each case at least one cylinder, and both cylinder groups are each equipped with a separate exhaust-gas line, and both exhaust-gas lines are connected to one another, and having two exhaust-gas turbochargers connected in parallel, a first turbine of a first exhaust-gas turbocharger being arranged in the exhaust-gas line of the first cylinder group, and a second turbine of a second exhaust-gas turbocharger being arranged in the exhaust-gas line of the second cylinder group, and the compressors assigned to these turbines being arranged in separate intake lines which converge downstream of the compressors to form a combined intake line and serve to supply the internal combustion engine with fresh air or fresh mixture.

The invention also relates to a method of operating a supercharged internal combustion engine of the abovementioned type.

Within the scope of the present invention, the term “internal combustion engine” includes both diesel engines and spark-ignition engines.

In recent years there has been a development toward small, highly supercharged engines, the supercharging primarily being a method of increasing the power in which the air required for the engine combustion process is compressed. The economical importance of these engines for the automotive industry is steadily increasing.

As a rule, an exhaust-gas turbocharger, in which a compressor and a turbine are arranged on the same shaft, is used for the supercharging, the hot exhaust-gas flow being fed to the turbine and expanding in this turbine while delivering energy, as a result of which the shaft is set in rotation. The energy delivered by the exhaust-gas flow to the turbine and finally to the shaft is used for driving the compressor, likewise arranged on the shaft. The compressor delivers and compresses the charge air fed to it, as a result of which supercharging of the cylinders is achieved.

The advantages of the exhaust-gas turbocharger, for example in comparison with mechanical chargers, consist in the fact that there is no mechanical connection for the power transfer between charger and internal combustion engine, or such a mechanical connection is not required. Whereas a mechanical charger draws the energy required for its drive entirely from the internal combustion engine and thus reduces the power provided and in this way adversely affects the efficiency, the exhaust-gas turbocharger uses the exhaust-gas energy of the hot exhaust gases.

A typical example of the small, highly supercharged engines is an internal combustion engine with exhaust-gas turbocharging in which the exhaust-gas energy is used for compressing the combustion air and which additionally has charge-air cooling, with which the compressed combustion air is cooled down before entering the combustion chamber.

As explained above, the use of exhaust-gas turbochargers has greatly increased in recent years, and no end to this development is in sight. The reasons for this are manifold and will be explained briefly below.

The supercharging primarily serves to increase the power of the internal combustion engine. Here, the air required for the combustion process is compressed, as a result of which a larger air mass can be fed to each cylinder per operating cycle. The fuel mass and thus the mean pressure p_{me can be increased as a result.}

Supercharging is a suitable means for increasing the power of an internal combustion engine at an unchanged swept volume, or for reducing the swept volume at the same power. In each case, the supercharging leads to an increase in the power density and in a more favorable power-to-weight ratio. Under the same vehicle boundary conditions, the load spectrum can thus be displaced toward higher loads, where the specific fuel consumption is lower. The latter is also referred to as downsizing.

Supercharging consequently assists the constant effort made in the development of internal combustion engines to minimize the fuel consumption, i.e. to improve the efficiency of the internal combustion engine, on account of the limited resources of fossil energy carriers, in particular on account of the limited deposits of mineral oil as raw material for the preparation of fuels for the operation of internal combustion engines.

A further basic aim is to reduce the pollutant emissions. The supercharging of the internal combustion engine can likewise help to achieve this object. This is because, if the supercharging is designed in a specific manner, advantages with regard to the efficiency and the exhaust-gas emissions can be achieved. Thus, by means of suitable supercharging, for example in the diesel engine, the nitrogen oxide emissions can be reduced without losses in efficiency. At the same time, the hydrocarbon emissions can be favorably affected. The emissions of carbon dioxide, which correlate directly with the fuel consumption, likewise decrease with decreasing fuel consumption. Supercharging is therefore likewise suitable for reducing the pollutant emissions. In order to maintain the future limit values for pollutant emissions, however, further measures are also necessary, which will be dealt with in more detail further below, since they are in particular the subject matter of the present invention. To begin with, however, the basic problems with the design of the exhaust-gas turbocharger are to be pointed out, and these problems are to be taken into account along with all the other measures.

The design of the exhaust-gas turbocharger causes difficulties, the aim in principle being to achieve a perceptible increase in power within all the speed ranges. According to the prior art, however, a pronounced drop in torque is observed if the speed falls below a certain value. This effect is undesirable, since the driver also expects a correspondingly large torque within the lower speed range in comparison with an unsupercharged engine of the same maximum power. The “turbo hole” at low speeds is therefore also considered to be one of the most serious disadvantages of exhaust-gas supercharging.

This drop in torque will be easily understood if it is taken into account that the charge pressure ratio depends on the turbine pressure ratio. For example, in a diesel engine, if the engine speed is reduced, this leads to a smaller exhaust-gas mass flow and thus to a smaller turbine pressure ratio. The result of this is that, toward lower speeds, the charge pressure ratio also decreases, which is tantamount to a drop in torque.

In principle, the drop in the charge pressure can be countered in this case by a reduction in the turbine cross section and the associated increase in the turbine pressure ratio, but this leads to disadvantages at high speeds.

In practice, the relationships described often lead to the use of an exhaust-gas turbocharger that is as small as possible, i.e. to an exhaust-gas turbocharger having a turbine cross section that is as small as possible. Ultimately, the drop in torque is thus only countered to a small extent and is shifted further toward lower speeds. In addition, there are limits to this procedure, i.e. to the reduction in the turbine cross section, since the desired supercharging and increase in power are also to be possible at high speeds in an unrestricted manner and to the desired extent.

According to the prior art, attempts are made to improve the torque characteristic of a supercharged internal combustion engine by different measures.

For example by a small design of the turbine cross section and simultaneous exhaust-gas bleeding, in which case the exhaust-gas bleeding can be controlled by means of charge pressure or by means of exhaust-gas pressure. Such a turbine is also referred to as a wastegate turbine. If the exhaust-gas mass flow exceeds a critical magnitude, some of the exhaust-gas flow is directed past the turbine in the course of the “exhaust-gas bleeding”. However, this procedure, as already discussed above, has the disadvantage that the supercharging behavior is unsatisfactory at higher speeds.

In principle, a small design of the turbine cross section together with charge-air bleeding is also possible, although this variant is rarely used on account of the disadvantages of the charge-air bleeding in terms of energy, i.e. on account of the impairment of the effective efficiency, and the existing compressors may reach their delivery limit, and thus the desired power may no longer be produced.

In diesel engines, a small design of the turbine cross section and the simultaneous limiting of the charge pressure by limiting the fuel mass at high speeds may serve the purpose. In this case, however, the possibilities of increasing the power by means of exhaust-gas turbocharging are not completely exhausted.

However, the exhaust-gas turbocharger can also be designed to be matched to high speeds with a large turbine cross section. In this case, the suction system is designed in such a way that dynamic supercharging is effected by shaft actions at low speeds. A disadvantage here is the high construction cost and the sluggish behavior during speed changes.

A turbine having a variable turbine geometry allows adaptation of the turbine geometry or of the effective turbine cross section to the respective operating point of the internal combustion engine, so that the turbine geometry can be regulated with regard to low and high speeds and also for low and high loads.

Furthermore, the torque characteristic of a supercharged internal combustion engine can be improved by register supercharging. In this case, a plurality of turbochargers connected in parallel and having correspondingly small turbine cross sections are selected with increasing load.

A plurality of turbochargers connected in parallel serve the purpose with regard to improving the torque characteristic even when they are configured in such a way that the cylinders of the internal combustion engine are divided into two cylinder groups, each having an exhaust-gas line, and an exhaust-gas turbocharger is assigned to each of the two exhaust-gas lines or each cylinder group. In this case, the turbine of the first exhaust-gas turbocharger is arranged in the exhaust-gas line of the first cylinder group, whereas the turbine of the second exhaust-gas turbocharger is arranged in the exhaust-gas line of the second cylinder group.

The compressors of the exhaust-gas turbochargers are arranged in two separate intake lines in a manner corresponding to the arrangement of the two turbines, these intake lines being brought together to form a combined intake line.

The exhaust-gas turbochargers or turbines arranged in parallel in this way allow the exhaust-gas turbochargers to be of smaller dimensions and allow the turbines to be designed for smaller exhaust-gas flows.

In addition to requiring a smaller construction space, two exhaust-gas turbochargers connected in parallel offer even further advantages. The response behavior of such a supercharged internal combustion engine is improved compared with a comparable internal combustion engine with only one exhaust-gas turbocharger. The reason for this can be found in the fact that the two smaller exhaust-gas turbochargers are less sluggish than one large exhaust-gas turbocharger, or the moving elements can be accelerated and decelerated more quickly.

As already mentioned above, further measures are necessary in addition to the supercharging in order to maintain future limit values for pollutant emissions. The focus of attention of the development work in this case is, among other things, the reduction in the nitrogen oxide emissions, which are highly relevant in particular in diesel engines. Since the formation of nitrogen oxides requires not only excess air but also high temperatures, a concept for the reduction of the nitrogen oxide emissions consists in developing combustion processes or methods with lower combustion temperatures.

Serving the purpose in this case is exhaust-gas recirculation, i.e., the recirculation of combustion gases from the exhaust-gas line into the intake line, in which the nitrogen oxide emissions can be markedly reduced with increasing exhaust-gas recirculation rate. The exhaust-gas recirculation rate x_{EGR} is determined as follows:
x_{EGR}=m_{EGR}/(m_{EGR}+m_{fresh air})
where m_{EGR} is the mass of the recirculated exhaust gas and m_{fresh} air is the fed fresh air or combustion air—if need be passed through and compressed by a compressor.

Exhaust-gas recirculation is also suitable for reducing the emissions of unburned hydrocarbons within the part-load range.

In order to achieve a marked reduction in the nitrogen oxide emissions, high exhaust-gas recirculation rates are necessary, which may be in the order of magnitude of x_{EGR}≅60% to 70%.

However, during the operation of an internal combustion engine, this results in a conflict between exhaust-gas turbocharging and simultaneous use of exhaust-gas recirculation, since the recirculated exhaust gas is extracted from the exhaust-gas line upstream of the turbine. This conflict can easily be illustrated with reference to an internal combustion engine with single-stage supercharging by one exhaust-gas turbocharger.

During an increase in the exhaust-gas recirculation rate, the remaining exhaust-gas flow fed to the turbine decreases at the same time. The smaller exhaust-gas flow through the turbine leads to a lower turbine pressure ratio. With decreasing turbine pressure ratio, the charge-pressure ratio likewise decreases, which is tantamount to a smaller compressor mass flow. In addition to the decreasing charge pressure, additional problems may arise during operation of the compressor with regard to the pumping limit of the compressor.

The effects described, i.e., the increase in the exhaust-gas recirculation and the simultaneous decrease in the charge pressure or compressor flow caused by this, lead to a richer fresh cylinder charge, i.e. to less fresh air or oxygen in the combustion chamber. This leads to increased soot formation, in particular during acceleration, for the fuel quantity often increases more quickly than the fresh air fed to the cylinders on account of the sluggishness of the moving elements of the exhaust-gas turbocharger.

For this reason, supercharging concepts are required which, in particular within the part-load range, ensure sufficiently high charge pressures with simultaneously high exhaust-gas recirculation rates. The conflict shown between exhaust-gas recirculation and supercharging is aggravated owing to the fact that the recirculation of exhaust gas from the exhaust-gas line into the intake line requires a pressure difference, i.e. a pressure gradient from the exhaust-gas side toward the suction side. In addition, in order to achieve the high exhaust-gas recirculation rates required, a high pressure gradient is necessary. This objective requires a low charge pressure or a charge pressure which is lower than the exhaust-gas counterpressure in the exhaust-gas line used for the exhaust-gas recirculation, a factor which contradicts the requirement established above for a high charge pressure.

The conflicts highlighted when exhaust-gas turbochargers and exhaust-gas recirculation systems are used at the same time cannot be resolved according to the prior art.

Against this background, the object of the present invention is to provide a supercharged internal combustion engine as claimed in the preamble of claim 1, i.e., of the generic type, with which the advantages known according to the prior art can be overcome and with which in particular high exhaust-gas recirculation rates and high charge pressures, in particular within the part-load range, can be realized at the same time.

A further partial object of the present invention is to show a method of influencing the quantity of recirculated exhaust gas of a supercharged internal combustion engine of the abovementioned type.

The first partial object is achieved by a supercharged internal combustion engine having at least two cylinders which are configured in such a way that they form two groups with in each case at least one cylinder, and both cylinder groups are each equipped with a separate exhaust-gas line, and both exhaust-gas lines are connected to one another, and having two exhaust-gas turbochargers connected in parallel, a first turbine of a first exhaust-gas turbocharger being arranged in the exhaust-gas line of the first cylinder group, and a second turbine of a second exhaust-gas turbocharger being arranged in the exhaust-gas line of the second cylinder group, and the compressors assigned to these turbines being arranged in separate intake lines which converge downstream of the compressors to form a combined intake line and serve to supply the internal combustion engine with fresh air or fresh mixture, wherein there is provided a line for the exhaust-gas recirculation, this line branching off upstream of one of the two turbines from the exhaust-gas line assigned to this turbine and opening into the combined intake line, and wherein there are provided means with which the magnitude of the exhaust-gas mass flow passed through one of the two turbines can be controlled, so that this turbine functions as selectable turbine.

The internal combustion engine according to the invention is equipped with two exhaust-gas turbochargers which are connected in parallel and whose turbines are arranged in separate exhaust-gas lines, the two exhaust-gas lines being connected to one another, so that the same exhaust-gas counterpressure prevails in the entire exhaust-gas system. For this reason, only one exhaust-gas recirculation system is required in principle in order to recirculate both hot exhaust gas from the first cylinder group and exhaust gas from the second cylinder group into the intake line. The compressors assigned to the two turbines are arranged in two separate intake lines which converge to form one intake line, so that these compressors jointly generate the charge pressure in the course of a single-stage compression.

According to the invention, means are provided which allow the exhaust-gas mass flow through one of the two turbines to be controlled. The turbine whose exhaust-gas flow can be controlled in magnitude by the means serves as selectable turbine in the internal combustion engine according to the invention. Thus exhaust gases flow continuously through one of the two turbines, whereas the exhaust-gas flow of the other, selectable turbine is influenced in such a way that the magnitude of this exhaust-gas flow can be adjusted. As a result, the exhaust-gas counterpressure is also influenced. This opens up in particular the possibility of generating the exhaust-gas counterpressure in the exhaust-gas system even at low loads or during small exhaust-gas mass flows, this exhaust-gas counterpressure being required for the exhaust-gas recirculation.

At low loads or during small exhaust-gas mass flows, the exhaust-gas mass flow through the selectable turbine is reduced or completely prevented, so that the predominant proportion of the exhaust gas or all the exhaust gas is directed through the other turbine. The turbine through which the exhaust gas mainly flows at the same time provides a sufficiently high turbine output in order to assist the build-up of the desired charge pressure. Within the part-load range, in particular within the lower and medium part-load range, this permits both the provision of a sufficiently high exhaust-gas counterpressure and a sufficiently high charge pressure required for the supercharging of the internal combustion engine.

With increasing load or increasing exhaust-gas quantities, the exhaust-gas mass flow passed through the selectable turbine is increased, so that sufficiently high exhaust-gas counterpressures and high charge pressures are also realized within the top part-load range and close to full load.

At this point it may be noted that the terms “low loads” and “high loads” within the scope of the present invention are to be understood to the effect that the entire load spectrum which is covered when completing the legally prescribed tests for determining the pollutant emissions is subsumed under the term “low loads”.

As a result, the invention directed to providing a supercharged internal combustion engine with which the disadvantages known according to the prior art are overcome and with which in particular high exhaust-gas recirculation rates and high charge pressures, in particular within the part-load range, can be realized at the same time.

The above comments are based on an internal combustion engine according to the invention in which the selectable turbine can be selected in an infinitely variable manner, i.e., the exhaust-gas mass flow directed through the selectable turbine is continuously variable. In principle, the internal combustion engine according to the invention may also be equipped with a turbine which can be selected in two stages and is either selected or shut down, which simplifies the control of the means provided. However, a turbine which can be selected in an infinitely variable manner has the advantage that it can be specifically adapted to the instantaneous operating point of the internal combustion engine and thus increases the flexibility of the supercharging and improves the quality of the supercharging.

For the abovementioned reasons, embodiments of the internal combustion engine in which the selectable turbine can be selected in an infinitely variable manner are advantageous.

Embodiments of the internal combustion engine in which the means for controlling the exhaust-gas mass flow is a shut-off element, preferably a valve, which is arranged in the exhaust-gas line assigned to the selectable turbine, are advantageous.

By means of the shut-off element, the cross section of flow of the exhaust-gas line which is assigned to the selectable turbine is varied, a reduction in the cross section of flow leading to a reduction in the exhaust-gas mass flow directed through the selectable turbine and to the desired increase in the exhaust-gas counterpressure in the exhaust-gas system. The increase in the exhaust-gas counterpressure also has an effect on the exhaust-gas recirculation rate. Due to the principle involved, the shut-off element is arranged in the exhaust-gas line of the selectable turbine, so that exhaust gas can be recirculated from the first and the second cylinder group into the intake line of the internal combustion engine by means of exhaust-gas recirculation under all operating conditions.

The shut-off element influences the exhaust-gas flow through the selectable turbine and thus indirectly, as a result of the increased exhaust-gas counterpressure, also the exhaust-gas mass flow through the other turbine. An adjustment of the shut-off element in the direction of the closed position reduces the exhaust-gas mass flow through the selectable turbine, and at the same time increases the exhaust-gas counterpressure in the exhaust-gas system and thus indirectly the exhaust-gas mass flow through the other turbine. Consequently, the turbine output provided by this other turbine is likewise increased, so that the compressor assigned to this turbine can perform greater compressor work, a factor which has an advantageous effect on the charge pressure.

Embodiments of the internal combustion engine in which the exhaust-gas line of the selectable turbine, for achieving maximum exhaust-gas counterpressures, can be completely closed by means of a shut-off element and embodiments in which this is not the case are both relevant to practice.

Embodiments of the internal combustion engine in which the shut-off element can be operated in two stages in such a way that it is either completely closed or completely open are advantageous. As already mentioned, this simplifies the control of the supercharging, for which reason this embodiment in particular has cost advantages over a turbine which can be selected in an infinitely variable manner. Furthermore, the possibility arises of operating the internal combustion engine during the tests for determining the pollutant emissions in such a way that the entire exhaust-gas flow is directed through one turbine during the entire test and the selectable turbine remains shut down. If the range within the engine characteristic map which is decisive during the test is departed from, the selectable turbine is activated.

Embodiments of the internal combustion engine in which the shut-off element can be controlled electrically, hydraulically, pneumatically, mechanically or magnetically, preferably by means of the engine control of the internal combustion engine, are advantageous.

Embodiments of the internal combustion engine in which the shut-off element is arranged in the exhaust-gas line from which the line for the exhaust-gas recirculation branches off, to be precise between the turbine assigned to this exhaust-gas line and the line for the exhaust-gas recirculation, are advantageous. Thus the additional lines to be provided for the exhaust-gas recirculation and the shut-off elements to be arranged are concentrated on one exhaust-gas line, a factor which offers advantages during assembly and maintenance with regard to the accessibility of the corresponding regions.

Embodiments of the internal combustion engine in which the shut-off element is arranged in the exhaust-gas line which does not serve for the exhaust-gas recirculation, to be precise upstream of the turbine assigned to this exhaust-gas line, are also advantageous.

Embodiments of the internal combustion engine in which the first turbine has a variable turbine geometry are advantageous. A variable turbine geometry increases the flexibility of the supercharging. It allows an infinitely variable adaptation of the turbine geometry to the respective operating point of the internal combustion engine. In contrast to a turbine having a fixed geometry, virtually no compromise has to be made in the design of the turbine in order to realize more or less satisfactory supercharging within all the speed ranges. In particular the charge-air bleeding, which is disadvantageous in terms of energy, but also exhaust-gas bleeding, as is carried out in wastegate turbines, can be dispensed with.

However, it is possible to design the first turbine for small or very small exhaust-gas flows in order to generate high exhaust-gas counterpressures and at the same time high charge pressures under these operating conditions—within the lower part-load range. Despite the variable geometry of the turbine, however, this necessitates exhaust-gas bleeding in order to also be able to operate the turbine or the exhaust-gas turbocharger during larger exhaust-mass flows and higher loads, in particular close to full load. To this end, the first turbine may be equipped with a bypass line for the exhaust-gas bleeding, i.e. the first turbine is of the wastegate type of construction.

In principle, however, the purpose is already served if the entire exhaust-gas system has at least one device for the exhaust-gas bleeding, since, in the internal combustion engine according to the invention, the two exhaust-gas lines assigned to the turbines are connected to one another and the same exhaust-gas counterpressure prevails in the entire exhaust-gas system. For this reason, the exhaust-gas bleeding may also be effected, for example, via a bypass line bridging the second turbine if the first turbine is designed for small or very small exhaust-gas mass flows and exhaust-gas bleeding is necessary in order to be able to operate the turbine during larger exhaust-gas mass flows and higher loads.

In particular, it is advantageous to design the other non-selectable turbine for small exhaust-gas mass flows, since, according to the invention, in the case of these exhaust-gas quantities, flow occurs predominantly or solely through this other turbine. The supercharging of the internal combustion engine within the lower and medium part-load range can thus be further improved. With increasing exhaust-gas quantity, the selectable turbine is activated and/or exhaust gas is bled via the other turbine. The selectable turbine is then preferably of larger design than the other turbine.

Turbines of smaller dimensions are thermally less sluggish on account of their smaller mass. On its way to the exhaust-gas aftertreatment systems, the hot exhaust-gas flow must flow through the turbines and gives off heat to the turbines there in particular during the warm-up period, with the exhaust-gas temperature being reduced, so that the heating of the turbines helps the catalytic converters arranged in the exhaust-gas duct to reach their light-off temperature with a time delay.

In addition, the response behavior of such a supercharged internal combustion engine is markedly improved. The reason for this can be found in the fact that smaller turbines or smaller compressors are less sluggish than larger turbines or larger compressors, since the moving elements can be accelerated and decelerated more quickly.

Advantageous in this case are embodiments of the internal combustion engine in which the first turbine forms the means for controlling the exhaust-gas mass flow, so that the first turbine forms the selectable turbine, adjustment of the turbine in the direction of a reduction in the cross section enabling the exhaust-gas mass flow passed through this turbine to be reduced.

Additional components, in particular a separate shut-off element, thus become unnecessary if the turbine, already present anyway, of the first exhaust-gas turbocharger is used for influencing the exhaust-gas mass flow and the exhaust-gas counterpressure. With the separate shut-off element, separate control of this element and the control unit required for this are also dispensed with.

However, embodiments of the internal combustion engine in which the first turbine has a fixed, invariable turbine geometry are also advantageous. In contrast to the above-described turbine having variable geometry (VTG), control is dispensed with here due to the principle involved. On the whole, therefore, this embodiment in particular has cost advantages.

Embodiments of the internal combustion engine in which the first turbine is designed as a wastegate turbine are also advantageous. For the purposes of exhaust-gas bleeding, “wastegate turbines” have a bypass line bridging the turbine. Such a turbine can therefore be specifically designed for small exhaust-gas flows, which markedly improves the quality of the supercharging within the part-load range. The turbine per se may have both a fixed, invariable geometry and a variable turbine geometry (VTG). With increasing exhaust-gas flow, a larger proportion of the exhaust gas is directed past the turbine via the bypass line. To control the exhaust-gas bleeding, a shut-off element is provided in the bypass line. A wastegate turbine with fixed turbine geometry is more cost-effective. The control is simpler and more cost-effective than in the case of variable turbine geometry. Embodiments of the internal combustion engine in which the first compressor assigned to the first turbine has variable compressor geometry are advantageous. As already explained in connection with the VTG turbine, a variable geometry increases the quality and flexibility of the supercharging on account of the possibility of an infinitely variable adaptation of the geometry to the respective operating point of the internal combustion engine.

In particular, if only a very small exhaust-gas mass flow is directed through the first turbine, a variable compressor geometry (VCG) proves to be advantageous, since, by adjustment of the blades, the pumping limit of the compressor can be displaced in the compressor characteristic map toward small compressor flows and thus work of the compressor on the other side of the pumping limit is avoided. This embodiment is especially advantageous when the turbine of the first exhaust-gas turbocharger has a variable turbine geometry and the compressor geometry is continuously matched to the turbine geometry.

A variable geometry (VCG) of the first compressor proves to be advantageous in particular in the cases in which the first turbine is operated as selectable turbine. If the exhaust-gas flow through the first turbine is reduced or completely prevented, this turbine provides a reduced output or no output for compressing the fresh air in the first compressor, so that there is the risk of the second compressor delivering into the first compressor and of the charge pressure in the intake line dropping as a result of a backflow in the first intake line through the first compressor. This adverse effect can be countered by adjusting the compressor geometry in the direction of the closed position.

Embodiments of the internal combustion engine in which the first compressor assigned to the first turbine has fixed, invariable compressor geometry are also advantageous. Compressors having a fixed geometry have cost advantages for the same reasons as turbines having a fixed geometry, namely on account of the simpler type of construction.

Embodiments of the internal combustion engine in which the first compressor assigned to the first turbine is equipped with a bypass line which branches off from the first intake line downstream of the first compressor and preferably opens again into the first intake line upstream of the first compressor are advantageous. To control the bled or recirculated fresh-air quantity, a shut-off element is provided in the bypass line. This embodiment of the compressor opens up further possibilities within the course of the supercharging. On the one hand, it allows the charge pressure to be set by means of the bled fresh-air quantity. On the other hand, it allows the bleeding of fresh air for the case where the first turbine serves as selectable turbine and a shut-off element is provided in the first intake line downstream of the compressor in order to prevent a backflow into the first compressor.

In particular, a bypass line bridging the first compressor allows the first exhaust-gas turbocharger, if it serves as selectable exhaust-gas turbocharger, to be brought to the pressure ratio of the other, second compressor without pumping. In this case, the first compressor delivers a volumetric flow which is proportioned in such a way that the compressor works within the stable range of the compressor characteristic map. Without the proposed bypass line, the compressor of the selectable exhaust-gas turbocharger would pump when running up to speed, since it could deliver only a small fresh-air mass flow when the shut-off element was closed.

Embodiments of the internal combustion engine in which a charge-air cooler is arranged in the combined intake line downstream of the compressor are advantageous. The charge-air cooler reduces the air temperature and thus increases the density of the air, as a result of which the cooler also helps to fill the combustion chamber with air more effectively, i.e., it contributes to a larger air mass.

Embodiments of the internal combustion engine in which the line for the exhaust-gas recirculation opens into the combined intake line downstream of the charge-air cooler are advantageous. In this way, the exhaust-gas flow is not passed through the charge-air cooler, and consequently this cooler cannot be contaminated by deposits of pollutants, in particular soot particles and oil, contained in the exhaust-gas flow.

Embodiments of the internal combustion engine in which an additional cooler is arranged in the line for the exhaust-gas recirculation are advantageous. This additional cooler reduces the temperature in the hot exhaust-gas flow and thus increases the density of the exhaust gases. As a result, the temperature of the fresh cylinder charge, which occurs during the mixing of the fresh air with the recirculated exhaust gases, is consequently further reduced, as a result of which the additional cooler also helps to fill the combustion chamber more effectively with fresh mixture.

Embodiments of the internal combustion engine in which a shut-off element is arranged in the line for the exhaust-gas recirculation are advantageous. This shut-off element serves to control the exhaust-gas recirculation rate. Unlike the means which are provided for controlling the exhaust-gas mass flow through the selectable turbine and which influence the exhaust-gas counterpressure and thus indirectly influence the EGR rate, the exhaust-gas recirculation can be directly controlled or even completely prevented with this shut-off element.

The preferred types of construction of the turbine and the compressor of the second exhaust-gas turbocharger will be explained below. The advantages of the individual types of construction, namely the variable geometry, the fixed geometry and the wastegate type of construction, have already been discussed in detail in connection with the first exhaust-gas turbocharger or the first turbine and the first compressor, for which reason reference is made at this point to the corresponding comments in order to avoid repetitions.

Embodiments of the internal combustion engine in which the second turbine has a variable turbine geometry are advantageous. In particular, the quality and flexibility of the supercharging is increased as a result. The geometry can be adapted to the exhaust-gas mass flow by adjusting the rotor blades.

Embodiments of the internal combustion engine in which the second turbine forms the means for controlling the exhaust-gas mass flow, so that the second turbine forms the selectable turbine, adjustment of the second turbine in the direction of a reduction in the cross section enabling the exhaust-gas mass flow passed through the second turbine to be reduced, are advantageous. Since the internal combustion engine according to the invention is of symmetrical construction with regard to the arrangement of the two turbines, both the first turbine and the second turbine may serve or be designed as selectable turbine.

Embodiments of the internal combustion engine in which the second turbine has a fixed, invariable turbine geometry are advantageous. This makes possible a cost-effective supercharging concept.

Embodiments of the internal combustion engine in which the second turbine is designed as a wastegate turbine are advantageous. This makes possible a cost-effective supercharging concept and at the same time a design of the turbine for small exhaust-gas mass flows, i.e. for the part-load range, which is of interest in particular with regard to the tests which are relevant for determining the pollutant emissions. In this case, the geometry of the second turbine may be invariable or variable.

Embodiments of the internal combustion engine in which the second compressor assigned to the second turbine has a variable compressor geometry are advantageous. As already mentioned above, the variable geometry in particular offers advantages on account of the possibility of displacing the pumping limit of the compressor. High charge pressures can also be generated during small fresh-air mass flows. If the first turbine forms the selectable turbine, a backflow into the compressor can be countered by setting the minimum cross section of flow of the compressor.

Embodiments of the internal combustion engine in which the second compressor assigned to the second turbine has a fixed, invariable compressor geometry are advantageous. Cost advantages and the simplification of the engine control of the entire internal combustion engine are prominent here.

Embodiments of the internal combustion engine in which the second compressor assigned to the second turbine is equipped with a bypass line which branches off from the second intake line downstream of the second compressor and preferably opens again into the second intake line upstream of the second compressor are advantageous. To control the bled or recirculated fresh-air quantity, a shut-off element is provided in the bypass line. The bypass line allows the charge pressure to be set by means of the bled fresh-air quantity and the bleeding of fresh air for the case where the second turbine serves as selectable turbine and the second compressor is separated from the combined intake line by means of a shut-off element provided downstream in order to prevent a backflow into the compressor.

Embodiments of the internal combustion engine in which, downstream of the compressor assigned to the selectable turbine, a shut-off element is provided in the intake line assigned to this compressor are advantageous. As already explained above, this shut-off element serves to avoid backflows through the compressor which is assigned to the selectable turbine if the selectable turbine provides no output or only a small output for the compression.

Additionally, a method of operating a supercharged internal combustion engine is presented, wherein at low speeds or at small exhaust-gas quantities, the means provided for controlling the exhaust-gas mass flow passed through the selectable turbine are controlled in such a way that the substantial proportion of the exhaust gas or all of the exhaust gas is passed through the other turbine, i.e., the exhaust-gas mass flow directed through the other turbine is greater than the exhaust-gas mass flow directed through the selectable turbine, and with increasing speed or increasing exhaust-gas quantity, the means provided for controlling the exhaust-gas mass flow passed through the selectable turbine are controlled in such a way that more exhaust gas is passed through the selectable turbine.

It may be noted at this point that the terms “low speeds” and “high speeds” within the scope of the present invention are to be understood to the effect that the entire speed range which is covered when completing the legally prescribed tests for determining the pollutant emissions is subsumed under the term “low speeds”.

The term “low loads” is to be understood to the effect that the entire load spectrum which is covered when completing the legally prescribed tests for determining the pollutant emissions is subsumed under this term.

What has been said in connection with the internal combustion engine according to the invention likewise applies to the method according to the invention. By the provision of means which are used to control the exhaust-gas mass flow passed through the selectable turbine, it is possible to realize high EGR rates and at the same time high charge pressures under all operating conditions, in particular at low speeds or low loads.

Although the arrangement of the two turbines in the two exhaust-gas lines is symmetrical, the two turbines are nonetheless operated or controlled differently. Whereas exhaust gas flows continuously through one turbine, the exhaust-gas flow through the selectable turbine is varied.

In internal combustion engines in which the means for controlling the exhaust-gas mass flow is a shut-off element which is arranged in the exhaust-gas line assigned to the selectable turbine and which can be operated in two stages in such a way that it is either completely closed or completely open, embodiments of the method are advantageous in which at low speeds or small exhaust-gas quantities, the shut-off element is completely closed, so that no exhaust gas is directed through the selectable turbine and all the exhaust gas is passed through the other turbine, and at high speeds or large exhaust-gas quantities, the shut-off element is completely opened, so that the exhaust gas is passed through both turbines.

In internal combustion engines in which the selectable turbine has a variable turbine geometry and forms the means for controlling the exhaust-gas mass flow, embodiments of the method are advantageous in which at low speeds or small exhaust-gas quantities, the geometry of the selectable turbine is adjusted in such a way that this turbine has its smallest cross section of flow, and with increasing speed or increasing exhaust-gas quantities, the geometry of the selectable turbine is adjusted in the direction of an increase in the cross section, so that the exhaust-gas mass flow directed through this turbine increases.

In internal combustion engines in which, downstream of the compressor assigned to the selectable turbine, a shut-off element is provided in the intake line assigned to this compressor, embodiments of the method are advantageous in which the shut-off element is completely closed if all the exhaust gas or more than 80% of the exhaust gas is directed through the other turbine.

Advantageous in this case are embodiments of the internal combustion engine in which the shut-off element is completely opened if the exhaust gas is directed through both turbines and at least 20% of the exhaust gas is passed through the selectable turbine.

In internal combustion engines in which, downstream of the compressor assigned to the selectable turbine, a shut-off element is provided in the intake line assigned to this compressor, and this compressor is equipped with a bypass line which branches off downstream of the compressor from the intake line assigned to this compressor, method variants are advantageous in which the fresh-air mass flow passed through this compressor is bled to the greatest possible extent if the shut-off element is completely closed.

The above advantages and other advantages, and features of the present invention will be readily apparent from the following detailed description of the preferred embodiments when taken in connection with the accompanying drawings, and from the claims.

### BRIEF DESCRIPTION OF THE DRAWINGS

The objects and advantages described herein will be more fully understood by reading an example of an embodiment in which the invention is used to advantage, referred to herein as the Description of Preferred Embodiment, with reference to the drawings, wherein:

FIG. 1 schematically shows a first embodiment of the internal combustion engine,

FIG. 2 schematically shows a second embodiment of the internal combustion engine,

FIG. 3 schematically shows a third embodiment of the internal combustion engine,

FIG. 4 schematically shows a fourth embodiment of the internal combustion engine,

FIG. 5 schematically shows a fifth embodiment of the internal combustion engine,

FIG. 6 schematically shows a sixth embodiment of the internal combustion engine,

FIG. 7 schematically shows a seventh embodiment of the internal combustion engine,

FIG. 8 schematically shows an eighth embodiment of the internal combustion engine, and

FIG. 9 schematically shows a ninth embodiment of the internal combustion engine.

### DESCRIPTION OF PREFERRED EMBODIMENT(S)

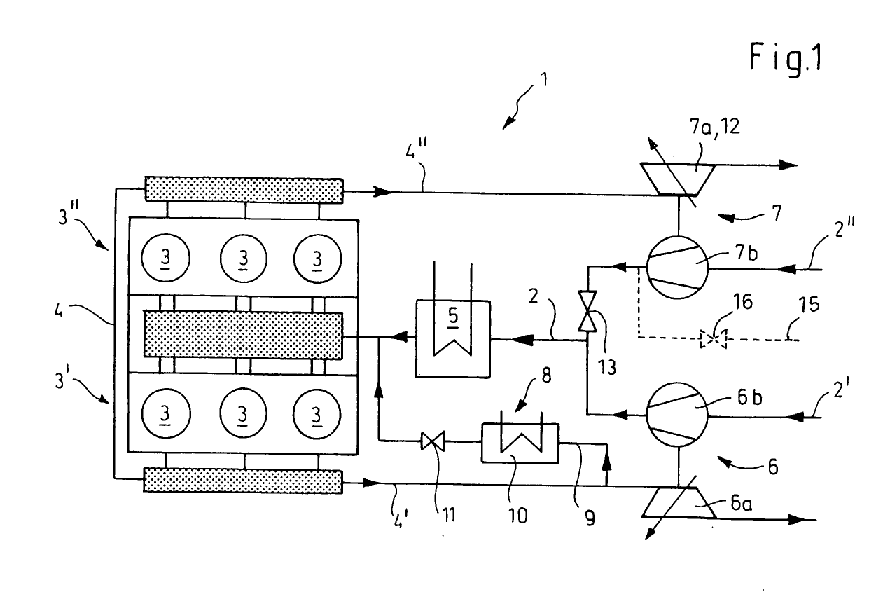

FIG. 1 shows a first embodiment of a supercharged internal combustion engine 1, taking a six-cylinder V engine as an example. The cylinders 3 of the internal combustion engine 1 are divided into two cylinder groups 3′, 3″ which each have a separate exhaust-gas line 4′, 4″, which are connected to one another and are used for discharging the hot exhaust gases of the internal combustion engine.

Two exhaust-gas turbochargers 6, 7 connected in parallel are provided, the first turbine 6a of the first exhaust-gas turbocharger 6 being arranged in the first exhaust-gas line 4′ of the first cylinder group 3′, and the second turbine 7a of the second exhaust-gas turbocharger 7 being arranged in the second exhaust-gas line 4″ of the second cylinder group 3″.

The compressors 6b, 7b assigned to these turbines 6a, 7a are likewise arranged in separate intake lines 2′, 2″, which converge downstream of the compressors 6b, 7b to form a combined intake line 2 and serve to supply the internal combustion engine 1 with fresh air or fresh mixture.

Downstream of the compressors 6b, 7b, a charge-air cooler 5 is arranged in the combined intake line 2. The charge-air cooler 5 reduces the air temperature and thus increases the density of the air, as a result of which it helps to fill the combustion chamber with air more effectively.

In the embodiment shown in FIG. 1, both the turbine 6a of the first exhaust-gas turbocharger 6 and the turbine 7a of the second exhaust-gas turbocharger 7 have a variable turbine geometry (VTG—identified by the arrow), which, by adjustment of the rotor blades, enables the turbine geometry to be adapted to the instantaneous exhaust-gas mass flow in an infinitely variable manner. This increases in particular the quality and flexibility of the supercharging.

The compressors 6b, 7b may have a fixed geometry or may likewise be designed with a variable geometry. A variable geometry is advantageous if the corresponding turbine 6a, 7a has a variable turbine geometry and the compressor geometry is continuously matched to the turbine geometry.

In particular during small exhaust-gas mass flows through the turbine 6a, 7a and the small compressor mass flows associated therewith, a variable compressor geometry (VCG) proves to be advantageous, since, by adjustment of the blades, the pumping limit of the compressor 6b, 7b can be displaced in the compressor characteristic map toward small compressor flows and thus work of the compressor 6b, 7b on the other side of the pumping limit is avoided.

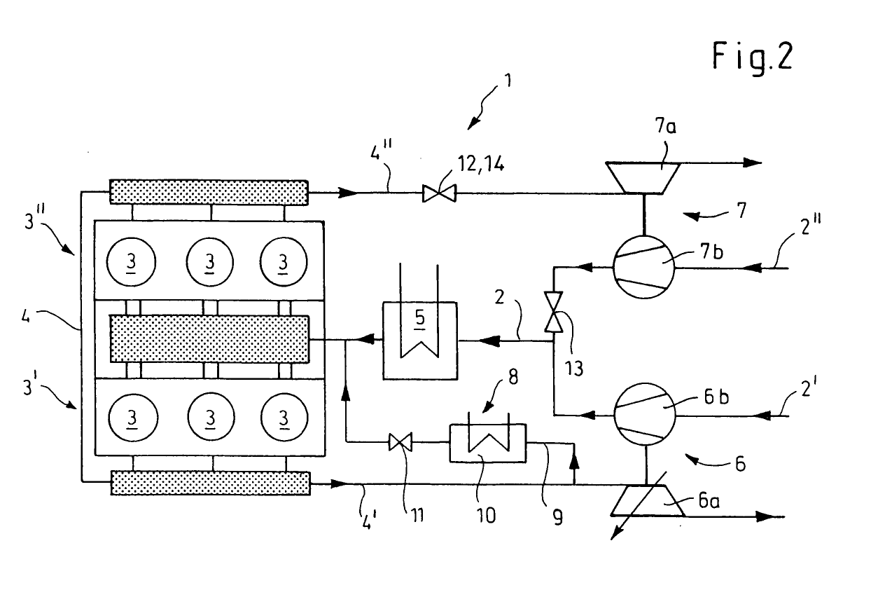

In principle, the compressors 6b, 7b may also be provided with a line 15 for charge-air bleeding. This is indicated for the second compressor 7b by way of example in FIG. 1 (shown by broken line). Downstream of the second compressor, a bypass line 15 branches off from the intake line 2″ assigned to this compressor 7b. A shut-off element 16 is arranged in the bypass line 15 for controlling the bled fresh-air quantity, and the charge pressure can also be set with said shut-off element 16. A further use of this bypass line 15 will be discussed further below. Such a bypass line 15 bridging the compressor 7b of the selectable exhaust-gas turbocharger 7 is helpful, in particular when running the selectable exhaust-gas turbocharger 7 up to speed, in order to avoid pumping of the compressor 7b. The first and/or the second compressor of the embodiments according to FIGS. 2 to 9 may accordingly also be provided with a bypass or bleed line.

The internal combustion engine 1 shown in FIG. 1 is provided with exhaust-gas recirculation 8. To this end, a line 9 for the exhaust-gas recirculation 8 is provided, this line 9 branching off upstream of the first turbine 6a from the exhaust-gas line 4′ assigned to this first turbine 6a and opening into the combined intake line 2. In this case, the line 9 for the exhaust-gas recirculation 8 opens into the combined intake line 2 downstream of the charge-air cooler 5. In this way, the exhaust-gas flow cannot be passed through the charge-air cooler 5 and cannot contaminate this cooler 5.

Provided in the line 9 is an additional cooler 10 which reduces the temperature of the hot exhaust-gas flow. A shut-off element 11 is likewise arranged in this line 9 for controlling the exhaust-gas recirculation rate.

According to the invention, one of the two turbines 7a is designed as selectable turbine 7a, means 12 being provided with which the magnitude of the exhaust-gas mass flow which is passed through this turbine 7a can be controlled.

In the embodiment shown in FIG. 1, the second turbine 7a, which has a variable geometry, serves as selectable turbine 7a and at the same time forms the means 12 for controlling the exhaust-gas mass flow through this selectable turbine 7a.

By adjustment of the turbine 7a in such a way that the turbine cross section is reduced, the exhaust-gas mass flow passed through the turbine 7a is reduced. At the same time, the exhaust-gas counterpressure in the exhaust-gas system increases, which is to be regarded as advantageous with regard to the exhaust-gas recirculation 8 and in particular with regard to high EGR rates. The exhaust-gas mass flow through the first turbine 6a likewise increases as a result of the increased exhaust-gas counterpressure, so that this turbine 6a provides the first compressor 6b with more output for compressing the fresh air, a factor which has an advantageous effect on the generation of sufficiently high charge pressures.

As a result of the reduction in the exhaust-gas mass flow directed through the selectable turbine 7a, the output provided by this turbine 7a decreases. If the exhaust-gas mass flow through the selectable turbine 7a is markedly reduced or completely prevented, there is the risk of the first compressor 6b delivering into the second compressor 7b and of backflows occurring in the second intake line 2″, a factor which has an adverse effect on the charge pressure. In order to prevent this, a shut-off element 13 is arranged downstream of the compressor 7b, assigned to the selectable turbine 7a, in the intake line 2″ assigned to this compressor 7b, and the compressor 7b can be separated from the rest of the intake system by means of this shut-off element 13. In this case, the bypass line 15 is opened for bleeding or recirculating the fresh air.

As an alternative to the shut-off element 13 downstream of the compressor 7b, the second compressor 7b, which is assigned to the selectable turbine 7a, may be provided with a variable compressor geometry (VCG). To avoid or reduce backflows in the second intake line 2″, the geometry of the compressor 7b is then adjusted in the direction of the closed position. The compressor 7b is preferably set in this case to its smallest cross section of flow.

It is possible to design the selectable turbine 7a and/or the other turbine 6a for small or very small exhaust-gas flows in order to generate high exhaust-gas counterpressures and at the same time high charge pressures under these operating conditions. However, despite the variable geometry of the turbine 6a, 7a, this necessitates a bypass line for the exhaust-gas bleeding and thus the wastegate type of construction (not shown) in order to also be able to operate the turbine 6a, 7a or the exhaust-gas turbocharger 6, 7 during higher exhaust-gas mass flows and higher loads, in particular close to full load.

FIG. 2 schematically shows a second embodiment of the supercharged internal combustion engine 1. Only the differences from the embodiment shown in FIG. 1 are to be discussed, for which reason reference is otherwise made to FIG. 1. The same designations have been used for the same components.

In contrast to the embodiment shown in FIG. 1, the second turbine 7a in the internal combustion engine 1 shown in FIG. 2 is designed with a fixed, i.e. invariable, turbine geometry. Unlike the above-described embodiment of the turbine with variable geometry (VTG), control is dispensed with here due to the principle involved. This embodiment in particular has cost advantages overall.

Nonetheless, the second turbine 7a again forms the selectable turbine 7a. However, since it has no variable turbine geometry, means 12 with which the magnitude of the exhaust-gas mass flow through the second turbine 7a is controlled must be provided.

To control the exhaust-gas mass flow, a separate shut-off element 14 is provided downstream of the second turbine 7a in the second exhaust-gas line 4″. With the shut-off element 14, the cross section of flow of the second exhaust-gas line 4″ is changed in an infinitely variable manner or is completely opened or completely closed in the course of a two-stage operation. A reduction in the cross section of flow reduces the exhaust-gas mass flow passed through the selectable turbine 7a and at the same time increases the exhaust-gas counterpressure.

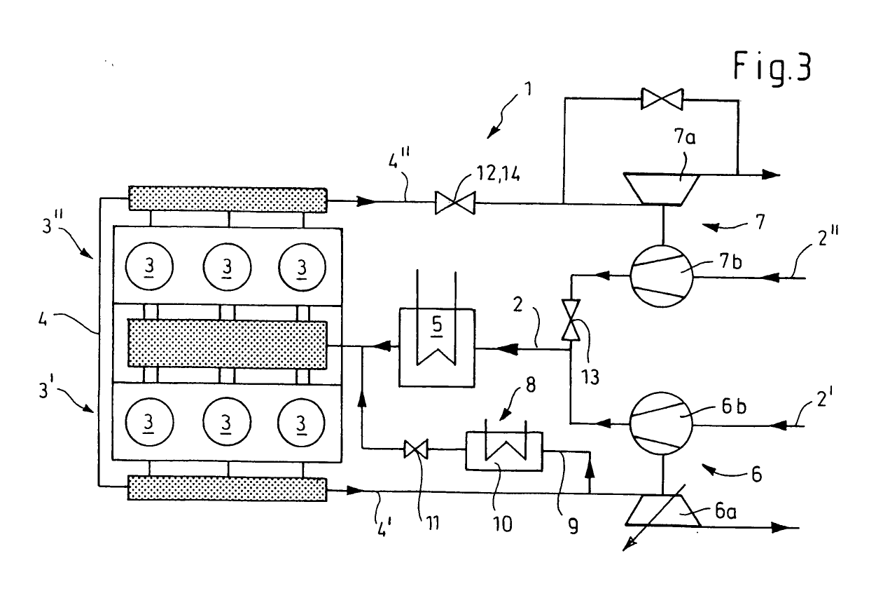

FIG. 3 schematically shows a third embodiment of the supercharged internal combustion engine 1. Only the differences from the embodiment shown in FIG. 2 are to be discussed, for which reason reference is otherwise made to FIG. 2. The same designations have been used for the same components.

In contrast to the embodiment shown in FIG. 2, the second turbine 7a in the internal combustion engine 1 shown in FIG. 3 is equipped with a bypass line, i.e. it is of the wastegate type of construction. This type of construction allows the second turbine 7a to be designed for small exhaust-gas mass flows.

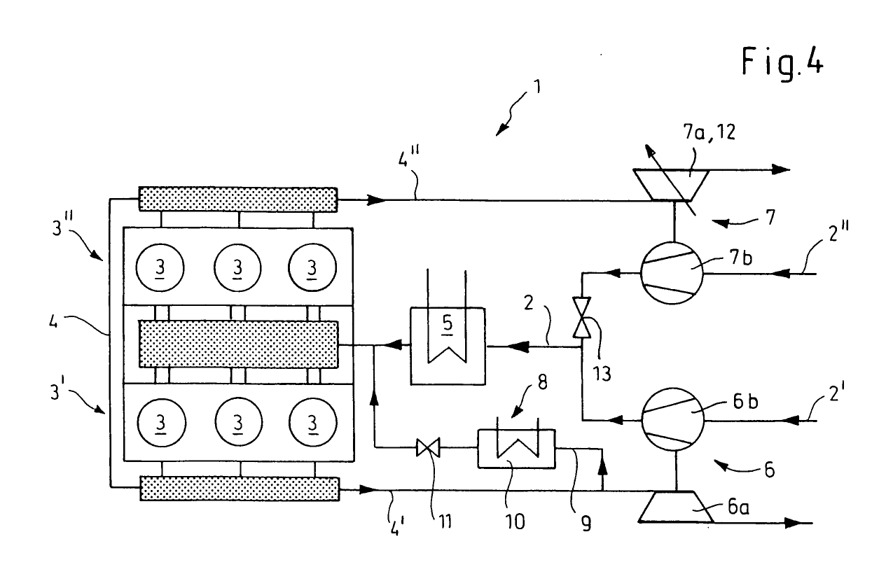

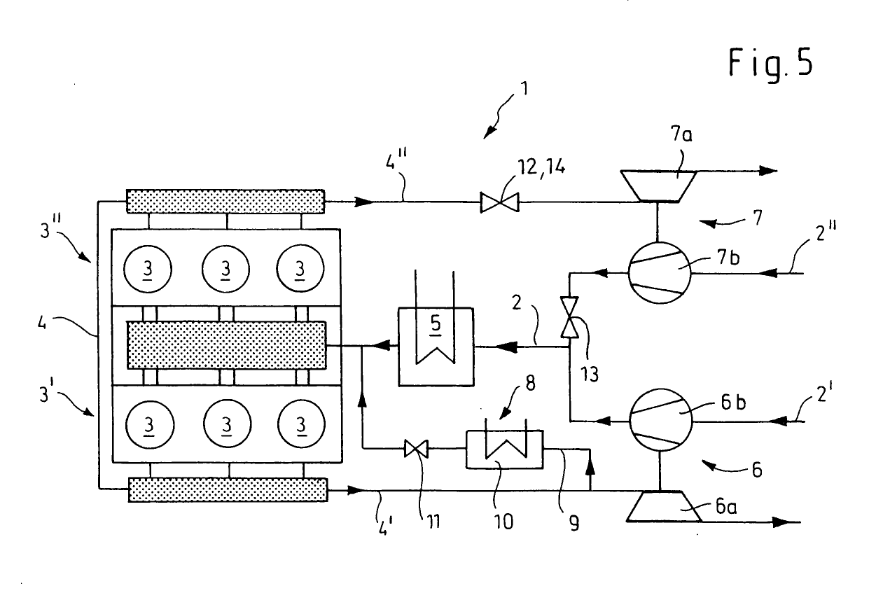

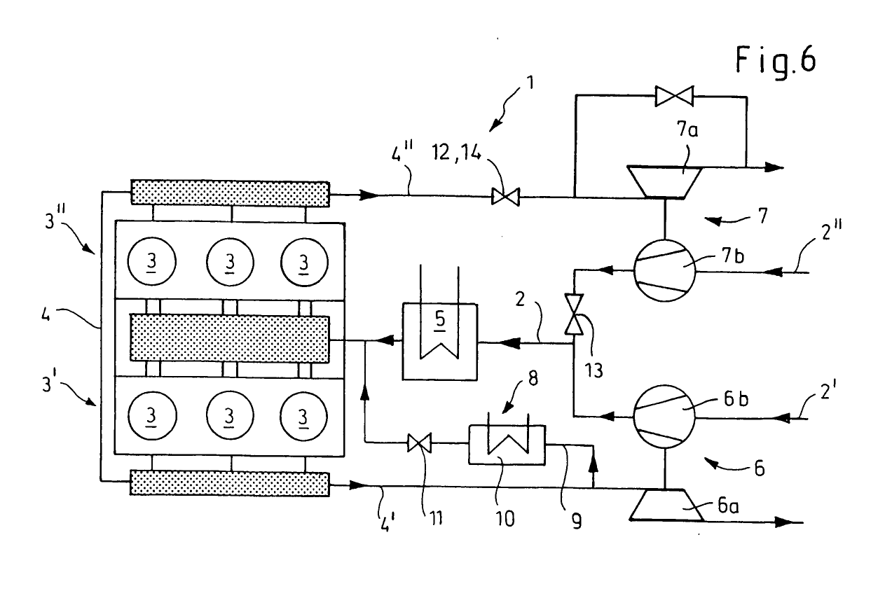

FIGS. 4, 5 and 6 schematically show a fourth, a fifth and a sixth respective embodiment of the supercharged internal combustion engine 1. Here, FIG. 4 is based on FIG. 1, FIG. 5 is based on FIG. 2 and FIG. 6 is based on FIG. 3. Only the differences from the embodiments shown in FIGS. 1, 2 and 3 are to be discussed, for which reason reference is otherwise made to FIGS. 1, 2 and 3. The same designations have been used for the same components.

The difference between the embodiments consists in the fact that the first turbine 6a of the internal combustion engine 1 is designed with a fixed, i.e. invariable, turbine geometry. Unlike a turbine with variable geometry (VTG), control is dispensed with here due to the principle involved. This embodiment has in particular cost advantages overall.

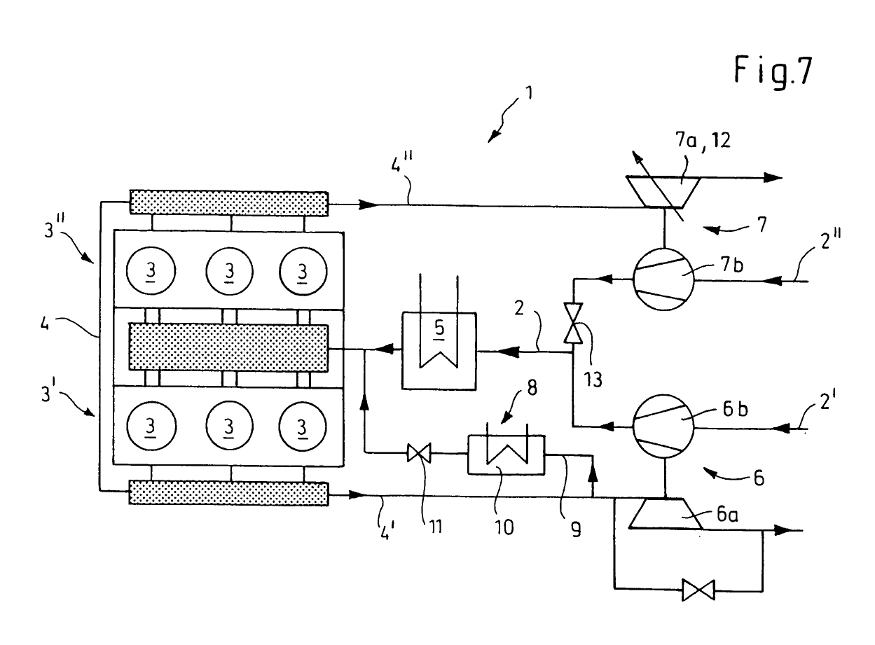

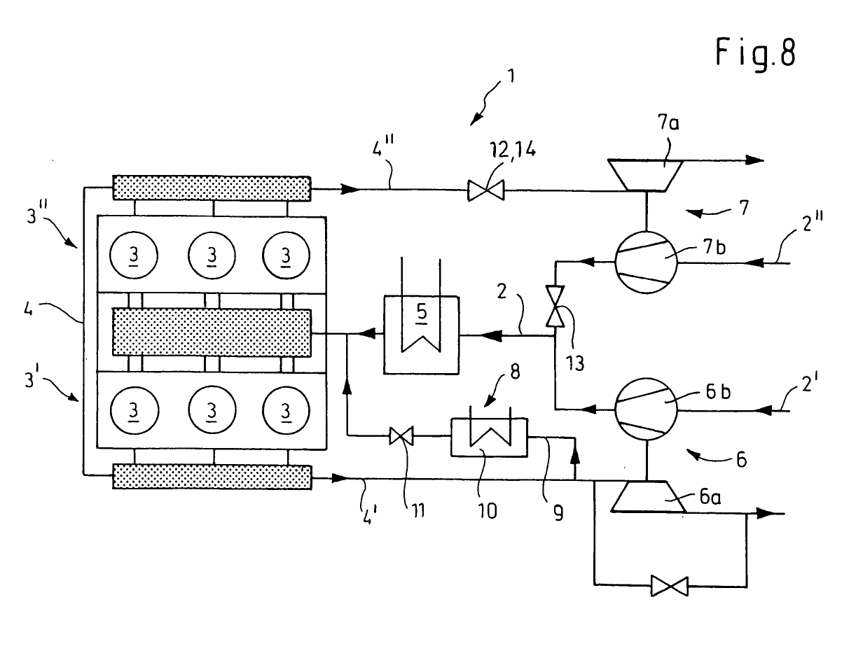

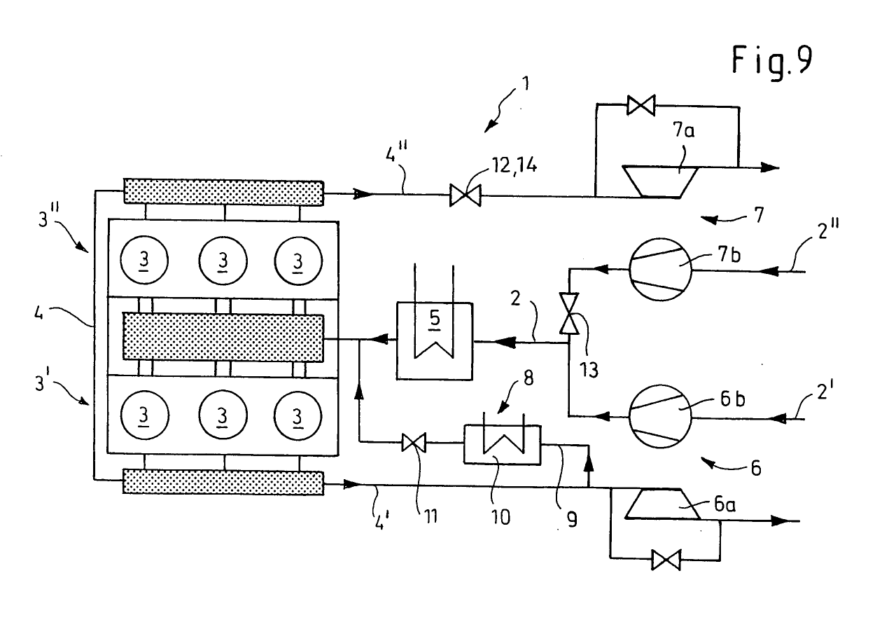

FIGS. 7, 8 and 9 schematically show a seventh, an eighth and a ninth respective embodiment of the supercharged internal combustion engine 1. Here, FIG. 7 is based on FIG. 1, FIG. 8 is based on FIG. 2 and FIG. 9 is based on FIG. 3. Only the differences from the embodiments shown in FIGS. 1, 2 and 3 are to be discussed, for which reason reference is otherwise made to FIGS. 1, 2 and 3. The same designations have been used for the same components.

The difference between the embodiments consists in the fact that the first turbine 6a of the internal combustion engine 1 is designed as a wastegate turbine. For the purposes of exhaust-gas bleeding, the wastegate turbine 6a has a bypass line avoiding the turbine 6a, which is a characteristic of this specific type of turbine construction. The turbine 6a is designed for small exhaust-gas flows, which markedly improves the quality of the supercharging within the part-load range. With increasing exhaust-gas flow, a larger proportion of the exhaust gas is directed past the turbine 6a via the bypass line. To control the exhaust-gas bleeding, a shut-off element is provided in the bypass line.

This concludes the description of the invention. The reading of it by those skilled in the art would bring to mind many alterations and modifications without departing from the spirit and the scope of the invention. Accordingly, it is intended that the scope of the invention be defined by the following claims:

1. A supercharged internal combustion engine having at least two cylinders which are configured in such a way that they form two groups with in each case at least one cylinder, and both cylinder groups are each equipped with a separate exhaust-gas line, and both exhaust-gas lines are connected to one another, and having two exhaust-gas turbochargers connected in parallel, a first turbine of a first exhaust-gas turbocharger being arranged in the exhaust-gas line of the first cylinder group, and a second turbine of a second exhaust-gas turbocharger being arranged in the exhaust-gas line of the second cylinder group, and the compressors assigned to these turbines being arranged in separate intake lines which converge downstream of the compressors to form a combined intake line and serve to supply the internal combustion engine with fresh air or fresh mixture, wherein a line for the exhaust-gas recirculation is provided, this line branching off upstream of one of the two turbines from the exhaust-gas line assigned to this turbine and opening into the combined intake line, and means with which the magnitude of the exhaust-gas mass flow passed through one of the two turbines can be controlled are provided, so that this turbine functions as selectable turbine.

2. The supercharged internal combustion engine as claimed in claim 1, wherein the selectable turbine can be selected in an infinitely variable manner.

3. The supercharged internal combustion engine as claimed in claim 2, wherein the means for controlling the exhaust-gas mass flow is a shut-off element, preferably a valve, which is arranged in the exhaust-gas line assigned to the selectable turbine.

4. The supercharged internal combustion engine as claimed in claim 3, wherein the shut-off element can be operated in two stages in such a way that it is either completely closed or completely open.

5. The supercharged internal combustion engine as claimed in claim 4, wherein the shut-off element is arranged in the exhaust-gas line from which the line for the exhaust-gas recirculation branches off, to be between the turbine assigned to this exhaust-gas line and the line for the exhaust-gas recirculation.
